(19) United States
(12) Patent Application Publication
(10) Pub. No.: US 2005/0149654 A1
(43) Pub. Date: Jul. 7, 2005

(54) Modular audio/video device and method

(76) Inventors: Marty Miller Holloway, Sacramento, CA (US); David Smith, El Dorado Hills, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 10/841,581

(22) Filed: May 6, 2004

Related U.S. Application Data
(60) Provisional application No. 60/534,503, filed on Jan. 6, 2004.

(51) Int. Cl. G06F 13/00

(52) U.S. Cl. 710/100

(57) ABSTRACT

Disclosed are a modular audio/video assembly and method of assembly. The modular audio/video assembly can include a housing and a main board disposed within the housing. A plurality of interfaces can be associated with the main board and each interface can be coupleable to a module that provides audio/video functionality for the assembly. The main board and the respective modules are cooperative to provide a set of selected audio/video functions. The assembly can operate on all digitized signals for optimum fidelity. A host within the assembly has an interface to a remote control to transmit to said remote control information for the modules in the assembly.

### RELATED APPLICATION DATA

This application claims the benefit of U.S. Provisional Patent Application Ser. No. 60/534,503, filed Jan. 6, 2004.

### TECHNICAL FIELD

The present invention relates generally to the field of audio and/or video equipment and, more particularly, to a modular audio/video (A/V) apparatus and method of preparing an A/V assembly.

### BACKGROUND

In recent years, there has been a vast proliferation of the amount of consumer oriented audio and/or video equipment for use mainly in private residences. For example, many audio and/or video equipment users have at least some of the following dedicated and self contained devices in a home entertainment center: a DVD player, an analog video recorder (e.g., a VCR), a digital video recorder (e.g., a digital video recorder (DVR), such as TiVo or Replay, that allows the user to capture and store video content in a digital format), a digital and/or analog audio receiver, an audio amplifier, a cable or satellite receiver box or other video tuner, a CD player and a video game player. Each of these devices physically consumes space and electrical power. The devices can also be difficult and/or confusing to integrate with one another and with a display device, such as a television. More specifically, users are often perplexed as to how to correctly wire each component together to maximize functionality and enjoyment of each product or group of products working together. As an example, it can be challenging to configure an amplifier to distribute an audio component of a video file read by a DVD player to a set of speakers and to simultaneously display a video component of the video file on a display.

Furthermore, each piece of conventional A/V equipment is uniquely designed around a core component (e.g., main board) that has no compatibility with other products, other than by connection of pieces of equipment together using standard interface wiring assemblies. In addition, each piece of conventional A/V equipment comes with a predetermined set of features and functions that cannot be altered by the consumer. The predetermined configuration of each piece of A/V equipment results in an inability for many users to purchase items having the exact features desired in an A/V peripheral. For instance, the user may end up spending more than desired for a product that delivers certain features, but includes additional features that are not of interest to the user. Alternatively, the user may purchase a product that ultimately does not meet their requirements or expectations.

Finally, the user interface for the current state of the art renders remote controls difficult to use because they require updating when new components are added. The current state of the art can be described as either one remote control per device; or a universal remote control that must be taught the correct command sequence for a particular home setup. Our modular home entertainment center enables the remote control to support the features that are contained within the host even as those features are updated or added to, simplifying the user interface considerably.

Accordingly, there exists a need in the art for a modular A/V assembly, a method of preparing an A/V assembly, and a method to control that modular A/V assembly using a simple remote control.

### SUMMARY

According to one aspect we disclose a modular A/V assembly, also referred to as the “device” or the “host” herein. The modular A/V assembly can include a housing; a main board disposed within the housing; and a plurality of interfaces associated with the main board, each interface able to be coupled to a module that provides A/V functionality for the assembly, and wherein the main board and respective modules are cooperative to provide a set of selected A/V functions.

According to another aspect we disclose a method of assembling an A/V assembly. The method of assembling the A/V assembly can include providing a housing and a main board having a plurality of interfaces; selecting at least one module having A/V functionality; and connecting the module to one of the interfaces such that the module and the main board cooperatively provide a set of selected A/V functions.

According to yet another aspect we disclose a second method of assembling an A/V assembly. The method of assembling the A/V assembly can include receiving a set of desired A/V functions from a consumer; and connecting a plurality of modules each having A/V functionality to respective interfaces of a main board such that the modules and the main board cooperatively provide the set of desired A/V functions.

According to yet another aspect we disclose a method for controlling the A/V assembly in an intuitive manner using a remote control. This is made possible by the modular nature of the device; the device can determine which functions are installed in it, and can efficiently communicate what those functions are to the remote control of the end user. The remote control interface can be simplified from a maze of buttons to a simple touch screen, with nested display screens based on the modules that are contained in the modular A/V assembly.

### BRIEF DESCRIPTION OF DRAWINGS

These and further features of the present invention will be apparent with reference to the following description and drawings, wherein:

FIG. 1 is schematic representation of a modular A/V assembly.

FIG. 2 is a block diagram of a modular A/V assembly.

FIG. 3 is a generalized block diagram of the bus structure of the A/V assembly.

FIG. 4A is a more specific block diagram for an embodiment of the A/V assembly using the Philips PNX 1500 or 1700 series processor as an example of the CPU used.

FIG. 4B is a more specific illustration of FIG. 4A showing components of the video processor that can be used as the audio/video source selector/multiplexer of FIG. 3.

FIG. 5 shows the appearance of the front of the modular A/V assembly.

FIG. 6 shows the appearance of the rear of the modular A/V assembly.

FIG. 7 demonstrates one embodiment of the modularity aspect of the modular A/V assembly.

FIG. 8 illustrates the control portion of the remote control by the modular A/V assembly.

FIG. 9 illustrates the initialization and sequence that the host performs on power up.

### DISCLOSURE

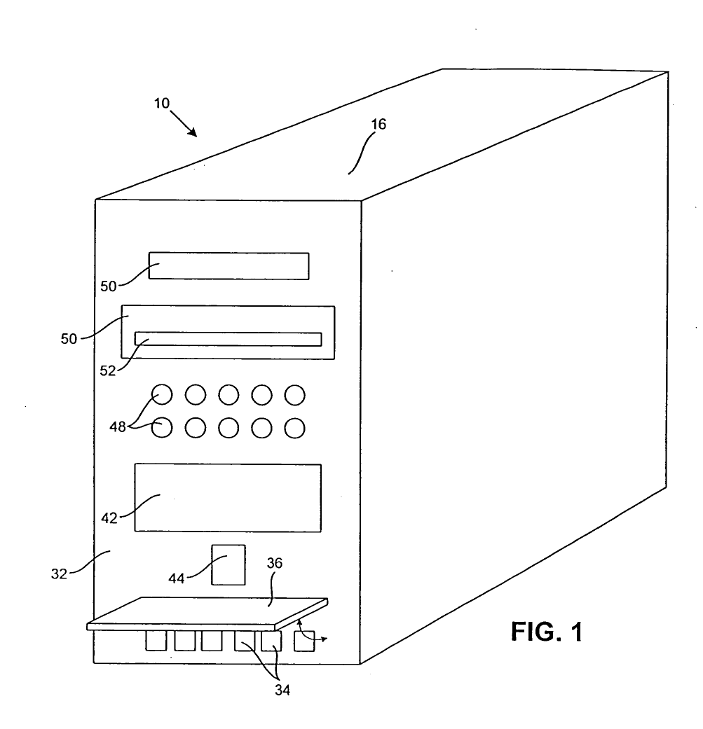

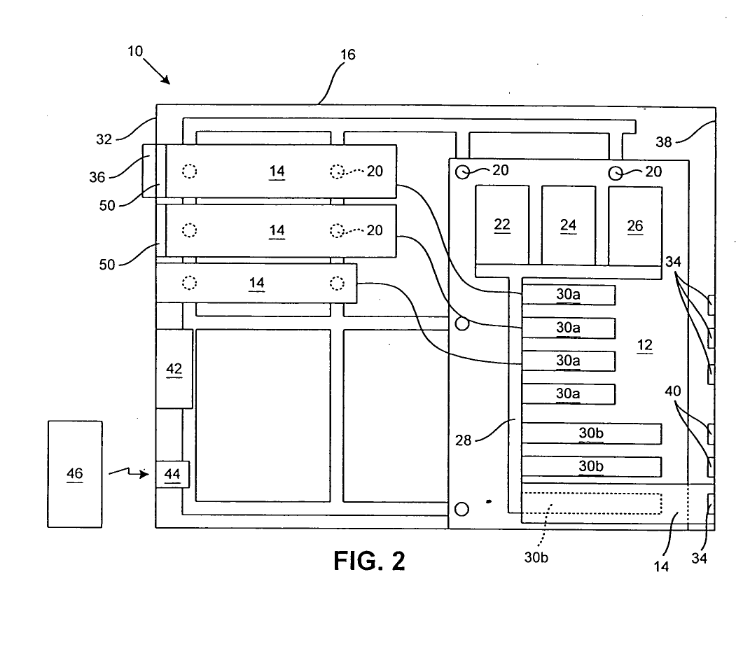

Referring to both of FIGS. 1 and 2, shown is an example embodiment of a modular A/V apparatus or assembly 10. FIG. 1 depicts a schematic representation of the assembly 10 and FIG. 2 depicts a functional block diagram of the assembly 10. Accordingly, FIGS. 1 and 2 are functionally consistent with each other, but the size, location and arrangement of corresponding components may not be shown with consistency from view to view.

As used herein, the term A/V is intended to refer to audio and/or video content, such as in the form of one or more of audio files, audio signals, video files, video signals, combined audio and video files, combined audio and video signals and combinations thereof. Therefore, the term A/V assembly refers to an apparatus capable of performing at least one A/V management function or task, such as the examples of storing, playing, editing, receiving, decoding, encoding, amplifying and transmitting A/V files and/or signals.

The modular A/V assembly 10 is a user upgradeable, modular platform for managing A/V content, including without limitation audio files and signals and/or video files and signals. It is noted that most video files and signals contain both a video component and an audio component, but will be referred to herein simply as video files and signals.

The assembly 10 has a main board 12 with a set of standardized interface features. In one embodiment, one or more modules 14 are provided. The modules 14 can be operatively coupled to the assembly 10 by the standardized interfaces of the main board 12. Each module 14 can perform one or more dedicated A/V tasks and can be added, removed or replaced as desired by a user of the assembly 10. In this manner, the assembly 10 and the A/V functions performed by the assembly 10 can be configured and reconfigured with a high level of flexibility.

The main board 12 can comprise a circuit board that is mounted in a housing, or chassis 16. For example, the chassis 16 can include an internal rack 18 to which the main board 12 is mounted with any suitable fastener, such as screws 20.

The main board 12 can include a video processor 22, such as a NEXPERIA PNX 1500 available from Philips Semiconductor, or any other suitable processing device for executing programmed logic instructions. In other embodiments, the processor can be a commercially available general use processor or an application specific integrated circuit (ASIC). The processor 22 can execute software routines to facilitate interaction with and among the modules 14. In addition, the processor 22 can execute software routines to carry out A/V management functions, to edit A/V files and signals, transcode A/V files and signals, convert video files and signals from 2D representations to 3D representations, and any other A/V processing.

Support circuitry and devices for the processor 22 can be included on the main board 12. Support circuitry and devices can include, for example, a memory 24 (e.g., RAM and/or ROM components), an A/V multiplexer 26 and/or a local interface 28 to operatively connect components of the main board 12. The memory 24 can store operating instructions in the form of code for execution by the processor 22. The code can comprise a set of operating system instructions and/or specified logic routines for carrying out specific functionality of the assembly 10. The memory 24 can also store data, various software programs and/or logic routine instructions, files and the like. In some embodiments, the memory 24 can also store A/V files and signals. Although illustrated with a single block, the memory 24 can comprise several devices and includes, for example, volatile and non-volatile memory components. Accordingly, the memory 24 can include, for example, random access memory (RAM), read-only memory (ROM), a hard disk, a floppy disk, a compact disk (e.g., CD, DVD, etc.), a tape, and/or other memory components, plus associated drives, writers and players for these memory types.

The processor 22 and the memory 24 can be coupled using the local interface 28, which can be comprised of a data bus with an accompanying control bus, a network, or other subsystem. The A/V multiplexer 26 can switch a desired video signal and/or audio signal from one of a plurality of sources to the video processor 22 over the local interface 28. The main board 12 can further include a video encoder (not shown) to encode signals output by the processor 22 and/or a video decoder (not shown) to decode signals transmitted to the processor 22.

The main board 12 can include a plurality of interfaces 30 for physically connecting the modules 14 to the main board 12 and operatively connecting the modules 14 to the local interface 28 and processor 22. In one embodiment, the interfaces 30 are physically and functionally based on a standardized format, such as peripheral component interconnect (PCI), industry standard architecture (ISA), or other peripheral interface standard adopted from the general purpose computing arts. Some of the interfaces 30a can be configured to physically connect to cables or wiring harnesses associated with the modules 14. Other interfaces 30b can be configured to physically connect to edge connectors of a card or board of the modules 14. For instance, the interfaces 30b can be embodied as PCI slots. It should be appreciated that the interfaces can be embodied with any suitable industry standard interface or a proprietary interface.

The modular A/V assembly 10 can also include a power supply (not shown) for supplying electrical power to the various components of the assembly 10, including the main board 12 and the modules 14.

As should be appreciated, the assembly 10 is configured with a desired permutation of A/V functionality by connecting modules 14 to the interfaces 30. The number of modules 14 and the function(s) performed by each module 14 can be selected by the purchaser or user of the assembly 10. For instance, the selection and installation of modules 14 can be carried out by the end consumer/user, by a vendor of the assembly 10 and/or by a manufacturer of the assembly 10. The assembly 10 can be custom built to order (e.g., with a set of modules 14 as selected by a purchaser) or with a default configuration as selected by the vendor and/or manufacturer. As indicated, each module 14 can perform one or more functions. Therefore, the modules 14 can include, but are not limited to, an analog and/or digital video tuner (or “TV tuner”) module, a cable box module, a repeater/emitter module for assisting in changing channels from a cable box or other device, a memory component module (e.g., hard drive or other data storage medium), an audio receiver (AM, FM, and/or satellite) module (optionally including an amplifier), a CD and/or DVD player and/or burner module, a digital video recorder module, a networking module(s) (e.g., an Ethernet card, a wireless adapter card, etc.), a peripheral input/output (I/O) interface module(s) (e.g., a USB port, a Firewire interface, a mouse interface, a keyboard interface, a Bluetooth or other wireless interface, a joystick interface, a video game control unit interface, a serial port, a parallel port, etc.), a portable memory reader module (e.g., a “memory stick” interface), an audio amplifier module, a video and/or audio interface module(s) with standard A/V ports (e.g., component ports, DVI ports, etc.), a video game player module, and combinations of these modules. Additional features and functions that can be embodied in one or more modules 14 are described below.

An aesthetic industrial design of the assembly 10 is preferred so that the assembly 10 can be showcased in a user's home entertainment center. For example, the chassis 16 can have smooth, flowing exterior surfaces. Connectivity aspects (e.g., jacks and connectors), or ports 34, (such as Firewire ports, A/V ports, USB ports, etc.) can be accessible from a front panel 32 of the chassis 16. In one embodiment, the ports 34 can be hidden behind a door(s) 36 or other feature. A rear panel 38 of the chassis 16 can have knockouts 40 (e.g., permanently removable covers or replaceable covers) so that various connectivity ports 34 of individual modules 14 can be selectively exposed. Additional connectivity ports 34 can be mounted on the rear panel. The connectivity ports 34 found on the front panel 32 and the rear panel 38 can be duplicative in nature. For example, industry standard video input/output jacks can be provided on both the front and rear of the chassis 16.

A display 42, such as an LCD panel, LED panel, or other illuminated panel can be provided on the front panel 32 to display information to the user regarding status of the assembly 10 and/or one or more of the modules 14. A receiver 44, such as an infrared (IR) receiver or a radio frequency (RF) receiver, can be provided on the front panel 32 to receive input signals from a remote device, such as a remote control unit 46. The remote 46 can have buttons, a display, and any other appropriate input/output components for interacting with the user so as to provide the user with at least partial control over operation of the assembly 10; however, the preferred embodiment of the remote control uses a touch screen and is detailed below. Similarly, user input devices 48, such as buttons and user input components, can be provided on the front panel 32 to provide the user with at least partial control over operation of the assembly 10.

Certain modules 14 can be mounted to be accessible from the front panel 32 of the chassis 16. For example, modules 14 can be attached to the rack 18 with brackets and/or fasteners (e.g., screws 20) to be positioned with respect to windows 50, doors 36 or knockouts 40 of the front panel 32. In one embodiment, CDs and/or DVDs can be inserted into a disk receptacle 52 (e.g., drawer or slot) of a module 14 through a window 50 defined by the front panel 32. In other embodiments, wires can be connected directly to a module 14 through the front panel 32 (e.g., through a window 50 and/or behind a door 36) and buttons of a module 14 can be accessible through the front panel 32 (e.g., through a window 50 and/or behind a door 36). Certain modules 14 can be accessible through the rear panel 38. For example, wires can be connected directly to modules 14 through the rear panel 38 (e.g., through an opening that was previously covered by a knockout 40). In other embodiments, certain modules 14 or portions thereof can protrude through the front panel 32 and/or the rear panel 38.

As indicated, the assembly 10 can be configured by a purchaser or end user of the assembly 10. For example, at the time of purchase, the purchaser can specify the features and/or specific modules 14 that the purchaser desires. Using the information gathered from the purchaser, a manufacturer or assembler of the assembly 10 can build the assembly 10 to meet the specified configuration. In one embodiment, the purchaser can select desired features, software packages and/or desired modules 14 using a client terminal (e.g., a general purpose computer executing a web browser) that interfaces with an Internet website hosted by a server. The Internet website can include menus (e.g., content specific selection menus, drop down menus, etc.), fields for the user to fill in, and any other appropriate user interactive features. In one embodiment, the user can specify functions that the user desires. Using the specified information, software executed by a computer of the manufacturer, with or without the assistance of a human operator, can generate a configuration of modules 14 and/or software programs (e.g., executable code to be “pre-installed” on the assembly 10) to implement the desired functions.

Once assembled, the assembly 10 need not be statically configured. For example, the purchaser, end user or service technician can add, remove and/or change functionality and/or modules by making corresponding changes to the modules connected to the main board. Other functionality can be added, removed and/or changed by making corresponding software and/or firmware changes to code that is stored by components of the main board 12 and/or the individual modules 14.

As should be apparent from the discussion herein, the modularity of the modular A/V assembly 10 exhibits several advantages over conventional A/V devices. For instance, the purchaser/user of the assembly 10 can custom arrange the assembly with modules 14 and/or executable software to carry out an exact set of functions of interest to the purchaser/user. This individual choice can result in the construction of an assembly having the features and functions desired by the purchaser/user and without undesired features and functions that may otherwise be present in “off the shelf” A/V equipment.

In addition, the amount of wire and tangling thereof can be reduced relative to conventional home entertainment arrangements by using the single chassis 16 having an internal bus structure to route most audio and/or video signals among various functional components.

The purchaser/user can also upgrade the assembly 10 after initial fabrication of the assembly by adding or replacing a module 14 or software component. Upgrading of the assembly 10 can allow for adding compatibility with a later developed technology, such as adding the ability to read a newly developed A/V storage medium. Upgrading of the assembly 10 can generally be carried out at a lower cost than purchasing an additional item of dedicated equipment. Furthermore, upgrading and/or changing a module 14 or software component can be carried out in a relatively straight forward manner. For instance, a purchaser/user who is familiar with installing a card in a PC and/or installing software on a PC ought to be able to perform upgrades and/or reconfigurations with minimal complications.

Additional advantages can be realized from other aspects of the present invention. For instance, the purchaser/user can order the assembly 10 directly from a manufacturer of the assembly 10, resulting in cost savings by establishing an end purchaser/manufacturer relationship. Parties other than the original equipment manufacturer of the assembly can create hardware modules 14 and/or software components for the assembly 10. Such third party components should have a high degree of compatibility with the assembly 10 due to the open architecture of the assembly 10 and, specifically, the use of standardized interfaces 30 for module 14 connectivity.

When ordering an assembly 10 from a manufacturer, the purchaser can be presented with options regarding which specific features and functions from various groups of features and functions will be represented in the purchaser's customized assembly 10. For instance, when ordering the assembly 10, the purchaser can be given the option to order a hard drive module or other memory component as part of the assembly 10 and, if the memory module is selected, the data storage capacity of such a memory. The purchaser can also be given the option of including a TV tuner with the assembly 10.

Additional categories of features and functions that can be embodied as a module 14 and/or software components can include input/output interfaces for, among other functions, transferring data, user input device interfaces, video functions, video input/output interfaces, and audio functions. The input/output interfaces can include, for example, a USB interface, an Ethernet Card, a Firewire interface, a portable memory (e.g., a “memory stick”) interface, a smart card interface/reader and a USB master. The user input device interfaces can include, for example, a mouse interface and a keyboard interface. The video functions can include, for example, a DVD player, a DVD burner, a cable tuner, a digital TV tuner, a second or auxiliary RF or TV tuner, a cable box controller (e.g., emitter/repeater), and a video tape player and/or recorder (e.g., a VCR). The video input/output interfaces can include, for example, RCA connectors, component video connectors, DVI connectors, co-axial cable connectors and HD15 (VGA) connectors. The audio functions can include, for example, an audio tuner, an audio amplifier, a digital audio receiver, a CD player, a CD burner and an MP3 player.

Larger assemblies can be constructed using the modular A/V assembly 10. For instance, the assembly 10 can be coupled to a television (not shown) for displaying video signals output by the assembly 10. The video signals output by the assembly 10 can originate from a storage medium that is read by a component of the assembly 10, a broadcast that is received by a tuner of the assembly 10, or an external device that is connected to a video interface of the assembly 10. Other devices that can be connected to the modular A/V assembly include, for example, a video game player, a still camera and/or video camera, one or more speakers, a general-purpose computer, a portable audio file or video file player, and so forth.

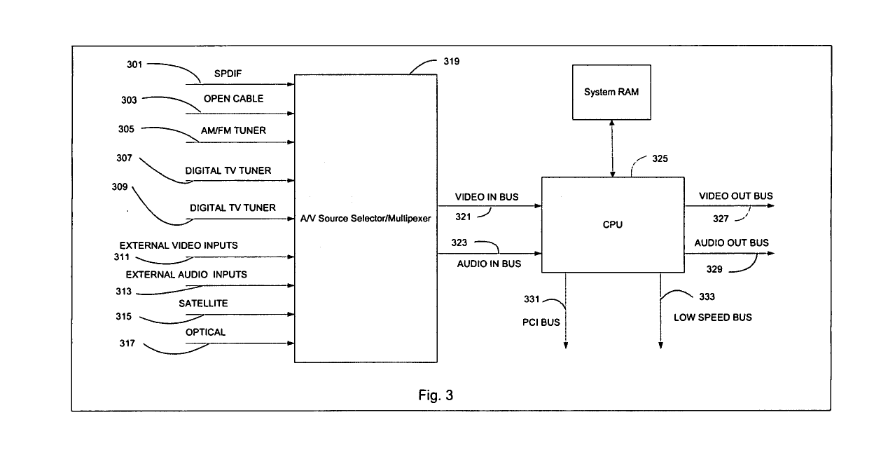

Referring to FIG. 3, the electrical bus structure of the modular A/V assembly or system is illustrated. The bus structure is very simple and designed with both modularity and audio/video processing in mind. This bus structure comprises:

A central processing unit 325 which may be a video processor;

Multiple A/V input sources or components 301, 303, . . . 317. Not all of these sources may be present or active simultaneously, but if more than one source is active, there should be a way for the device to select the correct source for both audio and video;

Two input buses to CPU 325-one for audio, audio bus in 321, and one for video, video bus in 323. These buses feed the data stream to be processed into the video processor 325;

An audio/video source selector/multiplexer 319 to select the appropriate A/V input source(s) for the user. The A/V input sources are connected to the A/V source selector/multiplexer 319 which selects the correct source to be processed by CPU 325 and puts the correct source on audio bus in 321 and video bus in 323;

A “fast” PCI bus 331 that can be used to stream data into or out of the assembly at speeds faster than real time video;

A “slow” or low speed bus, 333, that is used to transmit small volumes of data such as HTML that may be used to run the remote control;

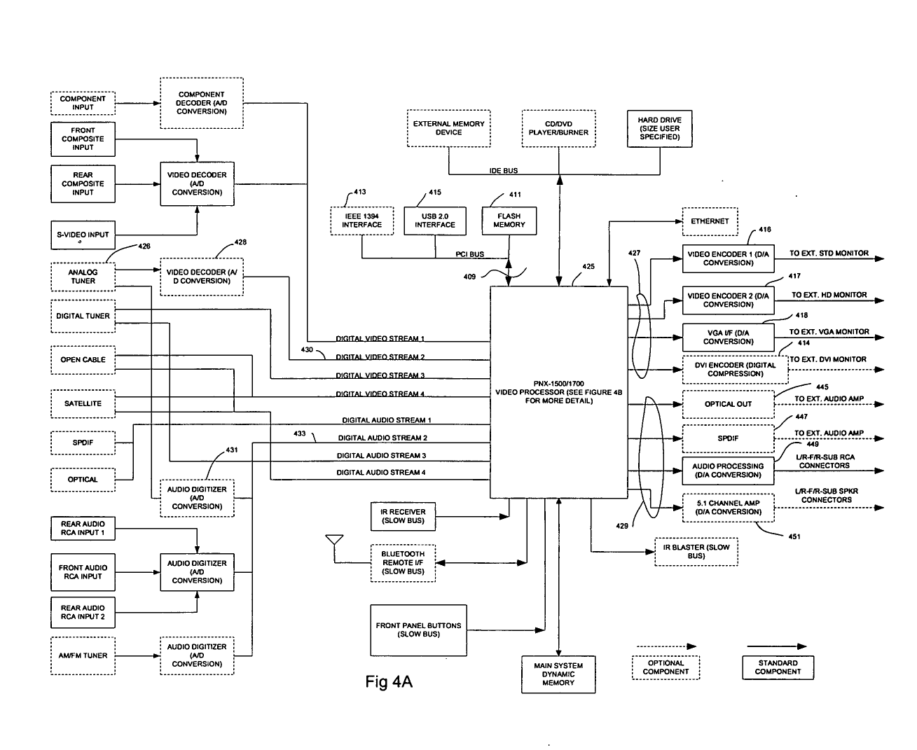

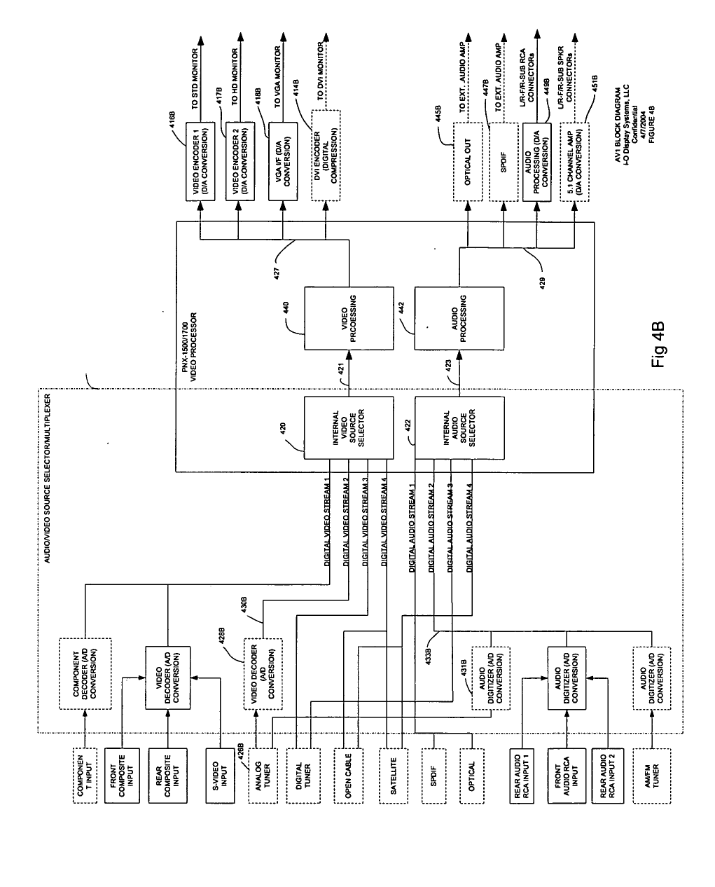

And, finally, the video out bus 327 and the audio out bus 329. These buses 327 and 329 are coupled to audio/video destination components such as monitors, audio amplifiers, and speakers as shown in FIG. 4A and as indicated in FIG. 4B, and to other destination components for which the manufacturer or user may design the system. Since the destination for audio and video are different, these buses should be independent of each other. The modular A/V assembly can be considered a host for audio/video components having controlled functions and, more particularly, the processor 325 within the modular A/V can be considered the host.

FIG. 4A shows a block diagram of an implementation of our modular A/V assembly using the Philips PNX 1500 or 1700 series of processors, 425, as CPU 325 of FIG. 3. While there are some differences with FIG. 3, the two diagrams, FIG. 3 and FIG. 4A, are functionally equivalent. Optional components are shown dotted in FIG. 4A. These components may be factory installed, installed by authorized service agents, or installed by the user. The determination as to whether a component is optional or standard will be based on cost, desirability of feature, and whether that feature is commonly standard in that particular class of equipment.

FIG. 4A has a number of input sources, just as FIG. 3 has. FIG. 3 shows these sources going into A/V source selector/multiplexer 319 and arriving at CPU 325 as a single source.

As can be seen in FIG. 4A, the following components reside on the PCI bus 409 that was shown at 331 on FIG. 3: flash memory 411; IEEE1394 (Firewire) 413, and USB 415. The latter two are fast transport mechanisms so that data can be streamed into or out of the apparatus at speeds much faster than real time video. For example, a ninety-minute DVD resolution movie can be copied over USB 2.0 in approximately 8 minutes.

The slow bus is not explicitly shown in FIG. 4A because of the multiplicity of devices that use this bus. The slow bus is used to communicate with buttons, IR remotes, Bluetooth, and the like. The slow bus may be I2C, parallel, or other bus protocol.

The Video Out bus 427 is shown in FIG. 4A going to four video encoders; one encoder, 416, can be for standard video; a second encoder, 417 that can be component video, a third component 418 for VGA output; and an optional component such as DVI encoder 414 for a digital high definition display. Similarly, the audio out bus 429 can be routed to both standard and optional components such as Optical Out 445, SPDIF out 447, audio processor and amplifier 449 and 5.1 channel amplifier 451, respectively. The arrows leaving the video and audio sections on the right go to an external device that is not covered under the scope of this patent. Alternatively, and as an option, cabling can be provided to allow the user to connect his or her own, more expensive, audio processor and amplifier into the system. This can be done in either the analog or the digital domain, although either can detract from the all digital architecture of the assembly that is described below. Degradation is clear for analog. Optical or SPDIF are digital, so the quality can be as good as the all internal design. However, there is a risk here of signal degradation from ground loops, bad connections, or the cable acting as an antenna.

The bus architecture outlined in FIG. 3 enables modularity of the design. The main board will have a number of openings for modules to be added. These modules may be slots, like in a PC, or they may be bays, as explained below. In any event, there is an interface on the main board for these modules to plug into. The interfaces for the modules will be routed with up to all six buses, the (fast) PCI bus 331, the low speed bus 333, the video in bus 321, the audio in bus 323, the video out bus 327 and the audio out bus 329, depending on the function that receptacle is used for. For example, some receptacles will be general purpose, and have all six buses routed to them. Other receptacles may be for a specific function, such as an external memory device, and so only need to have the fast bus 331 routed to it.

FIG. 4A also shows a novel, all digital architecture. The analog tuner module 426 is an optional feature. The audio and video signals are split apart within the tuner itself. The video signal is digitized via video decoder 428 and connected to the processor 425 via the Digital Video Stream 2 line. Similarly, the audio signal can also be digitized, via audio digitizer 431, and connected to the processor by the Digital Audio Stream 2 line. Thus, because of being digitized, the incoming analog audio and video signals are at the highest quality achievable when they arrive onto the main board. Alternatively, these signals may already be digitized when they enter the assembly. These include digital broadcast TV received through a tuner module, Digital Cable or Satellite. An analog to digital conversion is not required for these inputs. Similarly, there may be some outputs that are digital also such as DVI to the monitor, Optical or SPDIF to the Audio. Prior art apparatus use cables, typically analog, to connect various functions. Each analog connection made using cables can degrade the signal in a number of ways: converting between the analog and digital domain repeatedly; downscaling the resolution of the image; introduction of noise from connectors; introduction of noise from external radiation caused by cables acting as antennae; introduction of ground loops if all components are not properly grounded. The all-digital internal design essentially solves all of these problems. In this regard, the ultimate in retaining fidelity would be to have only the power cord and the speakers be analog.

A more specific illustration of FIG. 4A is seen in FIG. 4B. This figure more specifically illustrates taking advantage of multiple inputs available on the PNX chip. Thus, the audio/video source selector and multiplexer 319 of FIG. 3 is broken into several components in FIG. 4B that are contained both inside and outside the CPU chip 425 (which chip provides the CPU function illustrated at 325 in FIG. 3). The audio/video source selector/multiplexer 319 of FIG. 3 is seen in dash line format at 419 in FIG. 4B. Thus the audio/video source selector/multiplexer can, if desired, use some of the components of the CPU chip or it can be a separate unit 319 as seen in FIG. 3. It can be appreciated that this bus architecture does not necessarily link an audio and video source. The video and audio input sources are independent of each other. One feature of this independence is that the architecture of the device enables Digital Video Stream 4 line (for example) to be on the video in bus (321 of FIGS. 3 and 421 FIG. 4B), while Digital Audio Stream 2 line (for example) is on the audio in bus (323 of FIGS. 3 and 423 of FIG. 4B), simultaneously. This can be accomplished by selecting the appropriate digital video stream via internal video source selector 420 and selecting the appropriate digital audio stream via internal audio source selector 422. From a practical standpoint, this allows a user to watch a TV broadcast of a ball game while listening to the local radio feed of the same ball game. As used here, the term “broadcast” is not limited to television or radio broadcast, but could be Internet, intra net, intra- or inter-community or intra- or inter-company broadcast or similar communication. As another example of this feature, the user can listen to a local radio station while displaying JPEG images from a hard drive or external source.

The user would access the above feature through the remote control. An example of how this would work is as follows: the user would select a video viewing option. The audio would be the default source. However, the user would have the option to select an “alternate audio source” on the remote control. Selecting this option would display the audio sources available and allow the user to select one of these. A more sophisticated embodiment would allow the user to delay either the audio or video source to sync them up properly.

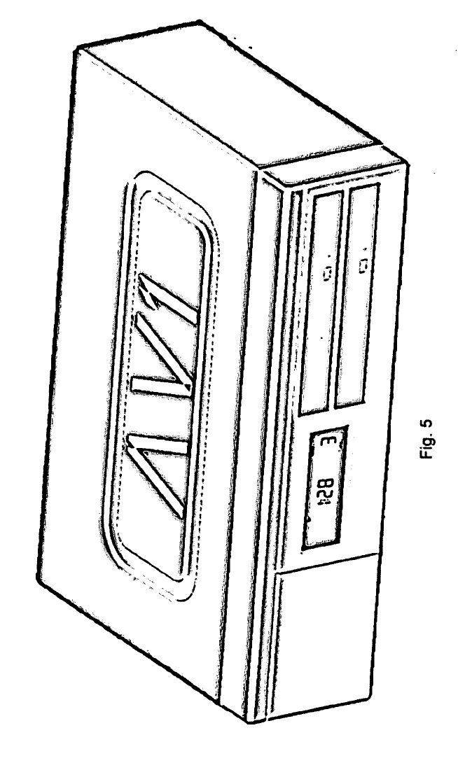

FIG. 5 shows the front of the apparatus. On the left hand side is a door that hides connections that are desired on the front of the device but that are not aesthetically pleasing. These include Firewire, USB, external memory devices, and analog A/V inputs. In the center is a display like those commonly seen in home A/V equipment. On the right in this example are two bays. This may serve many purposes: for example, a user may want to have two CDs that play sequentially for ease of use; a user may have a CD burner and DVD drive in the two bays. Another possibility is a split in video standards, similar to that which happened with BetaMax and VHS in the early days of home video. One bay could support each of the DVD replacement formats so that the user does not have to invest heavily in hardware that the marketplace may doom shortly.

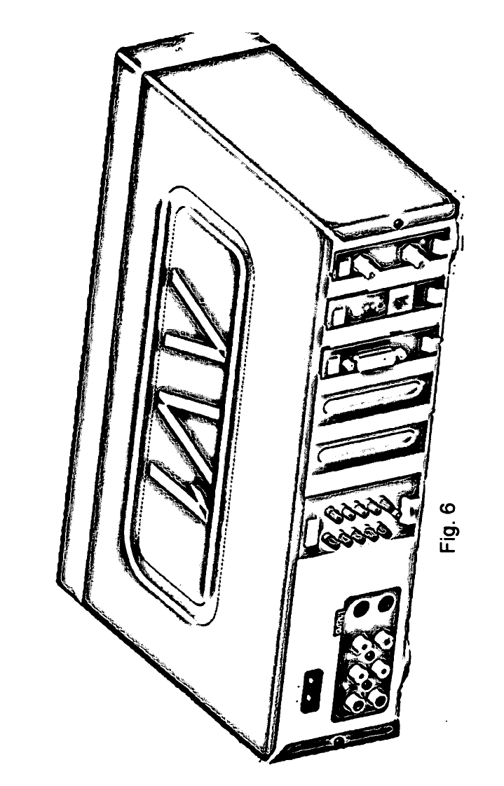

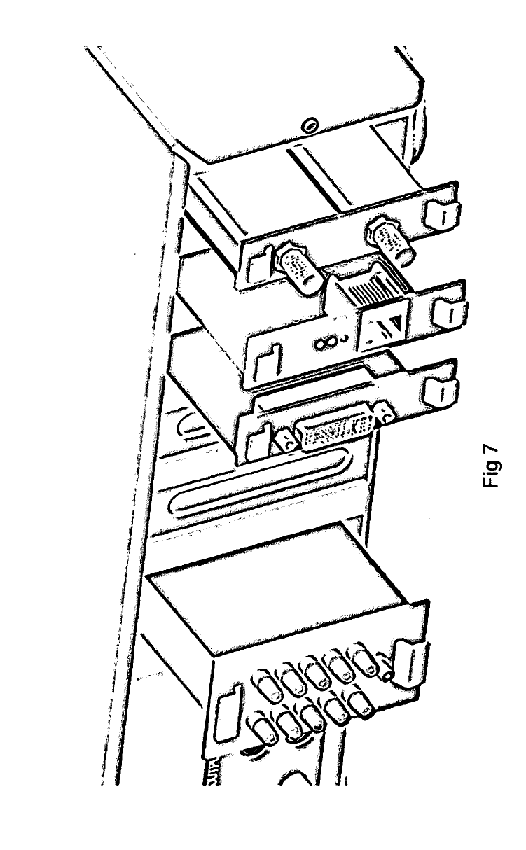

FIG. 6 shows the rear of the apparatus. On the left are standard outputs that are built into the device. On the right is a series of bays. FIG. 7 is a close-up of the bays, showing four modules in bays, and two unused bays. While slots are common in computers and are a potential embodiment of the device, the bays have a number of significant advantages over plug in cards. These include:

Safety: the user cannot access high voltage components, as he can when opening a case to replace a card.

Convenience: The user can accomplish the addition of a module much more quickly than a card.

Reliability: Often, cards do not seat properly. A module that slides in would create a more reliable, consistent connection.

Hot Swappability: The ability to add or removes modules from the bay while under power can be accomplished. The module is designed to lock into place mechanically. This locking mechanism would have a switch. Locking the mechanism would close the switch. The device would detect that a module has been added and apply power to it in a manner that will prevent it from being damaged. Similarly, when the locking mechanism is opened, the switch will open, and the receptacle will power down prior to removal.

From a functional standpoint, the device can respond to the addition of a module in one of two ways:

The first option is to recognize the new hardware. Since this hardware must be initialized, and initialization occurs at startup, the device would power cycle itself automatically. It would turn itself off, then reboot or power back up. During power up, the device would initialize the new hardware in accordance with its particular initializing procedure, load the appropriate drivers, and, if an Internet connection is available, possibly go to a website and check for newer versions of the driver for the hardware module.

The second option is to allow the user to control the timing of the reboot. Thus, power is not applied to the card and it is not initialized until the user power cycles the device. A message asking if the user wants to power cycle the device may appear on the screen and/or remote control so that he is informed that the device must be turned off for the new module to be recognized.

One further novel aspect of the device that the modularity enables is a very simplified remote control user interface. A conventional remote control has fixed functions and so does not work well with a modular, upgradeable host. Two control methods are discussed below:

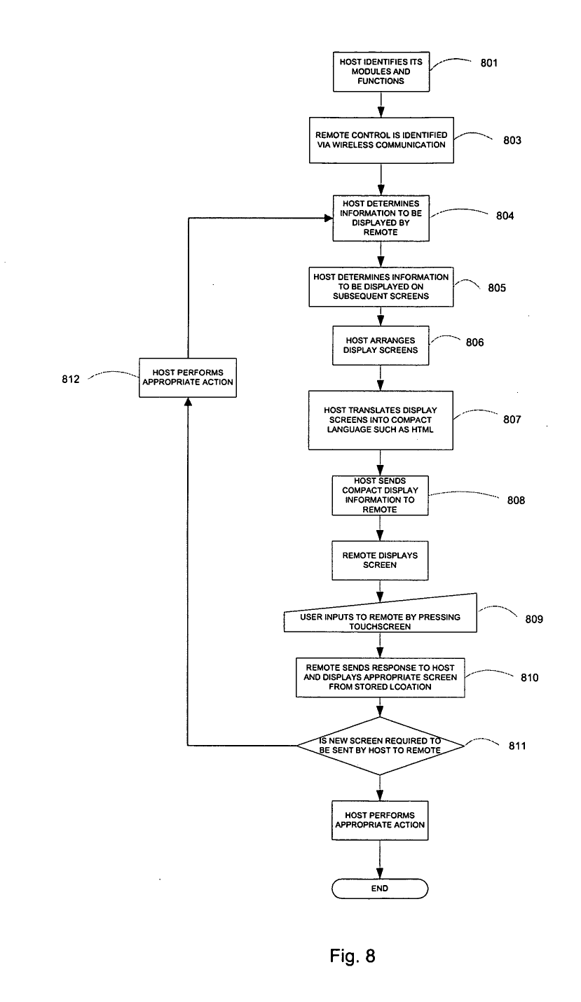

The first remote control method requires the host to have two-way communication with the remote. This can be accomplished with Bluetooth or some other well understood wireless technology. The remote control is seen in application Ser. No. ______ filed ______ and assigned to the common assignee. It is essentially a touch screen that displays a series of options for users to choose from. This menu of options is sent by the host, and can be sent one level deep for rapid display. To do this, the host performs the steps of FIG. 8:

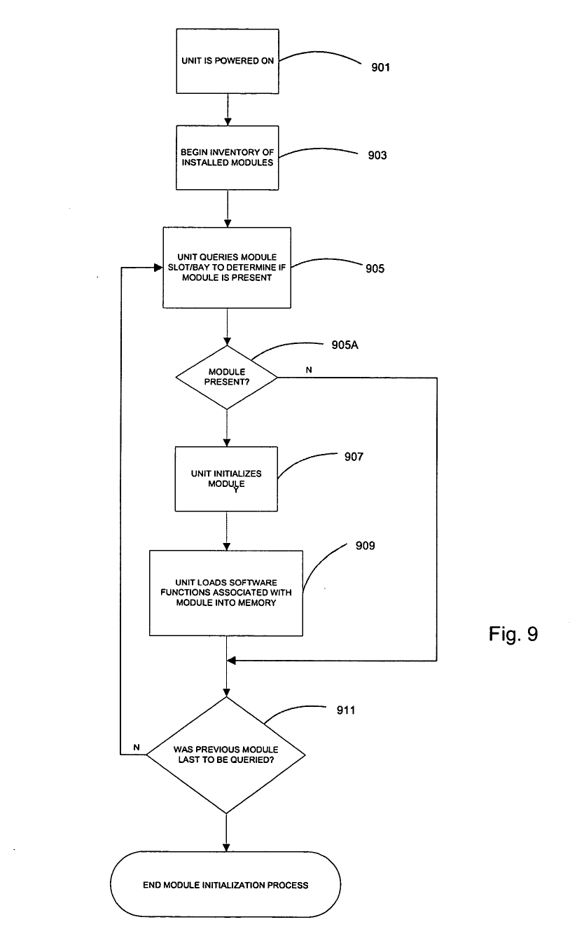

As seen at 801, the host identifies its own modules and the functions that those modules support. FIG. 9 shows the steps that the host takes to accomplish this function. The host begins the process upon application of power 901. The assembly is modular; thus, the host does not know which modules are present in particular interfaces when the assembly is first powered up. The assembly has a known number of interfaces, usually one for each bay. The host begins to inventory the installed modules, bay by bay, at 903, and at steps 905, 905A queries these bays sequentially, which can be done by querying each interface. If bay is empty and step 911 shows that the previous module was not the last one that is to be queried, the host queries the next interface or bay by proceeding again through the loop as at 905, 905A. If an interface is occupied, as seen at the “Y” exit of step 905A, the device interrogates the card contained in that interface to determine its type and, as appropriate, its configuration information, as at 907. This can be termed “initializing” the module. Once the type of card is known, the device loads the appropriate software modules for that card into memory as at 909. This step is included because the user may have purchased after market software that is associated with a particular card. For example, the user may have purchased an advanced video editor for home movies at the time that a Firewire card is purchased.

After the host has queried all interfaces sequentially, the host knows the hardware modules that are installed, along with their associated software programs. This inventory of installed modules can be stored so need be done only once per power cycle, and so need not be done again when the device is woken up from a power conserving sleep mode.

While the foregoing inventory process has been described in terms of a sequential process, it is well know that with the foregoing teaching the process can be implemented by a parallel process using hardware to store the installation status of each receptacle and the identity of each installed audio/video component, and inventorying or interrogating this hardware in parallel. Likewise interrogating the installation status of each receptacle and the identity of each installed audio/video component partly in parallel and partly sequentially does not depart from the scope of this invention.

In step 803, the host detects that the remote control is active in the vicinity of the host. This can be done by infrared detection or other well known means. To conserve power, the remote may be in the vicinity of the host but not always active. The term “active” means any signal that the remote control is ready to receive information. It may simply be a request transmitted by the user depressing a “send” key on the remote control to send a request, as well as other well known infra red, Bluetooth, or other technologies.

The remote is activated by pushing a button or touching the screen. Upon activation, the remote will display a screen that is stored internally. This screen may be a startup splash screen, or it may be the screen that was on the remote at the time that it became inactive. The relevant feature is that the act of displaying the screen upon activation is done from the internal memory of the remote, and not sent from the host.

In Step 804, the host communicates with the remote to determine the current screen that is displayed on the remote. This can be accomplished by sending a unique identifier with each screen to be displayed. This identifier is a digital word that may have a fixed or variable number of bits. In a simplified case of a four bit word, the remote would broadcast “1111” upon startup to indicate that it is displaying the startup screen. The host may respond by sending the identifier “0000” for the screen to be displayed, followed by the compact language version of the screen. The remote would display the screen it just received and broadcast “0000” to indicate the screen that is being displayed.

In the case above, the identifier is sent before the single screen. in the actual application, the identifier may be sent before and/or after the screen.

Additionally, the case of multiple screens being sent in a sequence must be considered. In this case, the identifiers for the multiple screens may be sent before and or after a particular screen, as detailed above; or the identifiers may be sent in list form as a series of pointers to the corresponding screens. This series of pointers may be sent before and/or after the data for the screens.

In Step 805, the host determines the subsequent screens to be displayed on the remote control based on the state in Step 804 and hardware and software modules that are loaded on the host.

If the remote control is displaying its startup screen (that can be loaded from internal memory on the remote) then the host will know that it needs to send the remote control a screen known as the “Home” screen. This screen is the starting point for the use of the remote. In this particular case, the remote also prepares, or arranges, the subsequent screens to the Home screen as at 806. This step gets the host ahead of what is displayed on the remote control, enabling the rapid display of subsequent screens.

If the remote is displaying a screen other than the startup screen, then communications have occurred previously between the remote and the host. The subsequent screens that are to be displayed are based on the options that are available on the screen that is currently displayed on the remote, as well as the hardware and software modules contained in the host.

The goal of this step is to identify what options the user may select next, and send the screens that are the response to these possible inputs to the remote to the remote so that it can quickly display the information to the user.

In step 806, the host can also format the relevant information for the subsequent display screens in a logical manner. This logical manner may take many factors into account:
a. The display screens can be formatted in a consistent manner-for example, with a description of the function in the top center, the “BACK” button in the same location, a universal layout for keypads, and the like.
b. Common functions should be grouped together. For example, “Channel Up” and Channel Down” should be located near each other.
c. Functions that are more frequently used may take a larger and/or more prominent display space than less commonly used ones. A given remote display screen may appear differently on two identically configured machines based on the usage patterns.

Examples of steps a and b, above can be seen in the copending application cited above.

Examples of step c above are given here:

In the first case, the host can base the display information on universal viewing habits. In other words, the host looks at which features have been accessed by the remote, how frequently those features are accessed, and how recently they have been accessed to determine which functions are used most frequently.

This can be accumulated and stored at the host or, given sufficient memory, can be accumulated and stored at the remote control for query by the host.

For example, two identical hosts in two locations have identical features: a DVD player, a hard drive and a tuner. The owner of the first host may watch mainly DVD movies, while the owner of the second host watches over the air broadcast over the tuner most often. The first host device may broadcast to its remote control the source selection screen with the area to select the DVD at the top of the display and consuming the majority of space. The second host device may broadcast the source selection screen that has the tuner selection most prominently displayed.

In the second case, a single host may base the screen configuration on an individual user's use preferences. For example, users could be tracked by I.D. or password and the home screen may consist of user names. Each user's preferences can be tracked as explained in the paragraph next above for universal viewing habits. The display screen is formatted in the manner explained above, but for each individual user, rather than for the entire host device.

The user selection of the remote may be password protected, enabling parental controls. A first adult user of the remote may have full access to the sources. A second adult user of the remote may have access to all features except pay per view. A third teenage user of the remote may not have access to any content rated “R” or “TV-MA”; and so on.

In step 807, after formatting the information, the host translates this display screen into a compact language format such as HTML for rapid transmission to the remote control.

In step 808, the host then sends this compact display information to the remote control, which stores this information for possible display by the remote control. This transmission can be accomplished through means that are well understood, such as Bluetooth or 802.11.

At this point in the process, the following has been accomplished: a display screen that the user can interact with is on the remote control, and the screen that will be displayed for any option the user chooses is stored on the remote control to be rapidly displayed.

At this point, step 809, the user selects an option on the remote control. The remote performs two functions, as described in step 810: The remote sends the response back to the host and displays the appropriate screen from internal memory (based on the user selection) on the remote. The response to the host can be sent as an XY pick location, or in other form.

The host then can make the determination as to whether there are additional subsequent screens to be sent to the display. An internal flag can be set for each screen that indicates if there are subsequent screens. The screen architecture can be top down; every screen that can be selected can be traced ultimately to a last screen, whose selections cause the host to perform an action.

If no subsequent screens are required, the host performs the requested action. Examples of such requested actions include changing the channel, adjusting the volume, fast forwarding video, etc.

If additional subsequent screens are required, as shown by the Y, or “Yes” decision out of step 811, the host performs the appropriate action (if any) at 812 and then returns to step 804 to determine the subsequent screens that are to be displayed. An example of this would be if the user selects “Cable” as the source of video. In this case, the appropriate action is to switch the Cable Audio stream onto the Audio In bus, and the Cable Video stream onto the Video In bus. In addition, subsequent screens such as “On Screen Guide,” “Video on Demand,” “Pay Per View,” etc. may need to be sent to the remote. If the N, or “No” decision is the output of step 811, then the host may perform other appropriate action.

A few concrete examples of the previous steps may be instructive.

Assume that the user has just installed the Modular A/V system and is using it for the first time. Upon powering up the host, the host will perform its internal inventory to determine what hardware and software modules are loaded. After completing this initialization process, the host begins broadcasting to find a remote. The remote will display the Startup screen until the remote and the host establish communication. Once communication is established, the host will send the “Home” screen to the remote.

The Home screen lists options for the user to select from, such as “Watch,” “Listen,” “Internet,” “Record,” “Games,” “Other.” These options are based on the included modules, which are known to the host because of the inventory it did upon startup. For example, “Internet” would not appear on the remote if the host does not have a web browser.

In addition to sending the “Home” display to the remote on startup, the host would also send the screens for any option that the user could select. In this case, the host sends six additional screens, one for each of the six functions supported: Watch, Listen, Internet, Record, Games, Other.

The user selects “Watch” from the Home screen. The “UVatch” screen on the remote loads quickly because it is already stored locally on the remote. This user selection is sent back to the host, which prepares the subsequent screens to be displayed based on the user selection.

A multiplicity of sources are supported by the host. An individual device may include any or all of the following: DVD player; Cable; Tuner; Internal Hard Drive; external analog source; external digital source, (such as a camcorder connected to a Firewire input.); and so on.

For this example, assume that this host has a DVD player, an internal hard drive, and an analog tuner. Thus, the host must prepare and send three subsequent screens to the “Watch” when the user makes his selection: one for the DVD player, one for the internal hard drive, and one for the tuner. The subsequent screen for each device is different. The DVD player has selections like Play, Pause, Fast Forward, Rewind, etc. The subsequent screen for the internal hard drive would display a file system so that the user can select a file to play back-and it would have its own subsequent screen similar or identical to the DVD screen, with the Play, Pause, Fast Forward, Rewind, etc. selections. The subsequent screen for the tuner is a keypad, with functions like Channel Up/Down, Favorites, Last, etc.

The host sends only the installed options to the remote for the user to select from-the other functions that the host supports but are not installed are not made available as options to the user. Because there is no Cable module installed in the example host, the user will not see any selections involving the Cable module.

In this example, the user selects the Tuner function. The keypad function is already loaded on the remote and so displays quickly. The remote communicates this selection to the host. In this case, the appropriate action for the host is to switch the tuner signals onto the Audio In and Video In bus. If the tuner is set to a channel that is broadcasting, this signal will be sent to the speakers and monitor. Since there is no subsequent screen to the keypad, the host does not need to send a subsequent screen to the keypad.

The user can now use the keypad to choose the channel to be watched.

As can be seen in the foregoing example, it is necessary for the host to know the software and hardware modules that are contained internally so that the remote displays the proper information. It is also necessary for the host to know the information that is currently displayed on the remote so that the host correctly interprets the response from the user and prepares the appropriate subsequent screen.

To continue the example, the user watches TV for a period of time. During this time, the remote has gone into a power saving sleep mode. The user desires to change the channel, and so activates the remote by touching the screen or a power button. The remote would still display the keypad, since that is the screen that was displayed when it went to sleep. The host needs to ascertain the display that is on the remote in order to properly respond to the user input. If the host does not confirm what is displayed on the remote, one can envision a situation where pressing a function on the remote causes the host to behave in an unexpected manner. As an example, if the number “3” is displayed on the remote and the “DVD play” button is in that same location in the screen that the host believes to be displayed, pressing the number “3” will cause the DVD to play.

A second embodiment of the remote control can be simplified even further. Rather than have the remote be used as the display device (LCD touch screen) the remote is simply a wireless mouse or other pointer device, and the host sends the information on the Video Out bus. The user navigates the screen with the mouse-like remote. The TV screen would be divided into functions that the user could select. When the pointer is over a selection, that selection would highlight, and pressing enter on the mouse-like device would select that option. This remote to host communication could also be performed using Bluetooth or other wireless technology. Note that in cases where there is already content on the screen, such as watching a movie, broadcast television, or cable, the screen can be reduced in size with the commands located along the top, bottom, or an edge; or the commands can be transparent overlays.

The described embodiment of the host interface for the remote control is a modular home entertainment center. However, the host can be a standalone box that has the ability to control existing home entertainment equipment through an IR transmitter/emitter or other suitable wireless technology, thus forming a system. This standalone host can perform similarly to the modular host, by having the IR codes to control these devices programmed into it. The standalone host would be programmed with the manufacturer and model of each piece of equipment to be controlled. Thus the standalone host would know the combined features of all equipment being controlled, and would be able to work in a coordinated manner to perform the desired function in the same manner as the modular A/V assembly host. For example, if the user selected a DVD as the source device, the host would perform the following functions: turn on the DVD player; turn on the audio amplifier and set the audio amplifier source to DVD; turn on the television monitor and set the monitor source to progressive input.

General Host Interface Interaction with Remote Control Device in Other Applications

The remote control is described here as being used principally to control an A/V entertainment center and the interface to the remote control is set forth as part of that entertainment center. However, the remote control can be used for other functions within the household and in commercial application. One household example is for use with one's home security system. In this example, the security system has a transmitter attached to the control panel. This transmitter broadcasts a signal to the remote control, indicating that it is present. When the user wants to access the security system, he or she presses its icon on the remote control's touchscreen, displaying the security system control panel. This control panel display may have the following icons: a 10 key pad, “ARM, “DISARM” “ENTER,” “PANIC” etc. If the house is not secure, this information may be sent to the remote. For example, the alarm would not set, and the remote would display “Kitchen Window Open” or “Motion in Hallway.” The remote also can display the status within the house. For example:
1:13:03 AM Rear Door Open
1:13:20 AM Correct alarm code entered at rear keypad
1:13:37 AM Motion In Living Room
1:13:52 AM NO motion in Living Room
1:14:01 AM Motion in Stairwell to 2nd Floor
1:14:28 AM Motion in Upstairs Hallway

This offers the opportunity to track the status within the house in real time-useful in case of a break-in or in surveillance.

Additional applications would be to control household appliances and other household items using the processes above. That is, instead of having the remote control interface in a modular audio/video assembly entertainment center as described above, it would be in a control panel or other appropriate control apparatus implementation and would use the same process to transmit control information as explained above with respect to an entertainment center or modular audio/video assembly. Examples of additional applications would be to control the following household matters:
Sprinklers;
Washer/Dryer;
Dishwasher;
warming up a Spa/Hot tub;
turn on the heat, the pump, the sweep, retract the cover of a swimming pool;
house fan;
control lighting, both internal and external;
turn on the speakers for external or multiple speakers in the home or in the backyard;
control the volume for the above speakers;
Fish feeder control;
turning on and off the Coffee maker
setting and turning off the Alarm clock
turning on and controlling personal computers;
turn off or on Water features such as fountains and the like
Alarm systems
Gas Grill
Gas Fireplace
Thermostat

Similarly, this remote control interface can be used as part of a wireless WAN or LAN and then perform all of the above control functions over the Internet.

Below are additional examples of some of the above home devices to be controlled by this remote, as well as examples for commercial applications. In these examples, a transmitter that knows the features contained within its host controls the displays that are shown on the remote as was described for the modular A/V assembly above. Some of these devices are sophisticated to use, such as:

Sprinkler Systems. In this case there can again be an existing control panel that can be easily mapped to the remote control display. A sprinkler has multiple zones that turn on and off at specified times. Thus, when the remote functions as sprinkler control, as an example of the first option the user would select is zone. Then a daily or weekly calendar for that zone would appear, as explained for sending subsequent screens in the modular A/V assembly case, and the user can specify on times and off times for each zone.

Pool. The pool has a number of features that can be controlled. These include timing of the main filter pump and pool sweep, controlling the water temperature, retracting the cover, etc. These functions can be controlled by the remote control in real time or pre-set, individually, or grouped together. For example, upon activation of the remote, the user may have three options to choose from: “Control Pool Now”; “Daily Pool Functions” “Pool Party”,

In the first case, “Control Pool Now”, for example, the user could turn the filter pump and pool on sweep for a specified or indefinite length of time using the remote. Furthermore, the controller can have the intelligence to know that the sweep must only be turned on fifteen minutes after the main filter, and be turned off fifteen minutes before the main filter to prevent burning the motor out.

In the second case, “Daily Pool Functions” the user can specify the filter to run daily from 9 AM-11 AM daily using the remote in a manner similar to that outlined for the sprinklers.

In the third case, “Pool Party” the user would use the remote to specify the time of the pool party, such as Saturday from 2 PM to 8 PM, as well as the desired pool temperature. The pool controller would complete a series of actions, such as:
turning on an electric or solar heater to increase the water temperature to the desired state in time for the pool party;
checking pool chemical levels to ensure that it is in a safe operating range;
running the filter and sweep for a specified period of time to ensure that the pool is clean prior to the party;
retracting the pool cover at the specified time to conserve heat and maintain cleanliness;
turning off the heat and running the filter after the party has concluded;
again checking pool chemical levels after the party and adjusting as necessary.

Thermostat. The remote can be used to control a thermostat. The user can base this control on day, time, temperature, or other factors. For example, the remote can set a Monday through Friday temperature control sequence and a separate control sequence for weekends, when the house is occupied all day. The user could set the whole house fan to turn on when the internal temperature exceeds the external temperature by a specified amount, and leave the fan on until the house reaches a desired temperature. The remote could be used to set different temperatures in different rooms or area of the house. For example, the upstairs sleeping quarters may be warmer at night than the downstairs living area.

External Speakers. The remote may be used to turn on external speakers and adjust their volume.

Lights (internal and external). The remote may be used to control internal and external home or other building lights. It may turn lights on or off, act as a dimmer, or change settings of external lights from each function to another. These external lights are typically tri-state: Always on, dawn to dusk, and motion detecting.

Spa. These features are similar to the pool outlined above. The user can specify water temperature, the timer, control which jets are active and the like.

Gas Grill. The user could turn on the gas grill remotely at a specified time, and set the internal temperature. Gas pressure could be monitored, informing the user if gas is running low. The grill could be set to turn off at a specified time. In a similar way, a gas fireplace could be controlled. Both of these devices would have automated feedback loops to ensure that a safety hazard is not created. For example, if a heat source is not detected, then the gas would be turned off to prevent a potentially explosive buildup of gas.

Personal Computer. The remote could be used to control a PC also. This would be useful in a wired home, where the PC is a central server for home entertainment functions. The remote can be used to turn the PC on or off, as well as activate and control its various functions: browse the web, stream a stored video file to a monitor anywhere in the house using a wireless LAN; or perform other functions that the PC supports anywhere in the house.

The remote can be used to set timers on simple devices such as coffee makers, alarm clocks, pet feeders curtains, blinds, or shutters so that they open or close at specified times of the day, or the user can control them manually using the remote control.

Oven. The remote control can control the oven to preheat it to desired temperature, or send the oven into a self cleaning mode. Similarly, it can be used to control a microwave. For example, the microwave could be set to go through a certain cycle to defrost and then cook a dish.

There are also other devices that the remote can control, such as washers/dryers, dishwashers and air conditioner. Since the user is required to be next to these devices prior to use, it may initially appear that there is no problem to be solved by a remote. However, these devices are often noisy, and it may not be desirable to leave them running when outside the home. Thus, the remote can be used to turn such devices off when leaving the house, or turn them on when going to bed. Furthermore, the remote can be used to notify the user that these devices have completed their cycles. The remote can also notify the user of the device's status-if the washer has been run and the door not opened, the remote would remind the user that there is a wet load of laundry in it.

The remote can be used to control a series of devices. For example, assume that it is nighttime, and the user has just gotten into bed. The user sets the alarm for 6 AM and presses the “BEDTIME” button. The remote then performs the following functions: turns on appropriate exterior lights; turns off appropriate interior lights; turns on the dryer and dishwasher; and sets the alarm. In the morning, the lights turn on and increase in brightness gradually prior to the alarm time so that the lights are fully on at the specified wakeup time. Similarly, the radio is turned on at a low volume at the same time as lights turn on, gradually increasing the volume until it is at normal volume at the specified wakeup time. This gradual increasing of the light and gradual raising of volume will ease the user out of slumber, rather than jarring the user. Or the house lights may come on, as programmed. The coffee maker has already been programmed to have coffee ready at the same time as the alarm is set for. The external lights can be turned off at a specified time.

This remote can also be used to establish a pattern for leaving the house for the day, ensuring that all lights are turned off, the security system set, and all major appliances turned off, if desired.

In the event that the house will not be occupied for a period of time, such as a vacation, the remote can be used to set a sequence that the lights, radios, televisions, and other controlled devices can run. As part of the vacation routine, the time at which these events occur may be variable, based on user settings. This variability may draw less attention than if certain lights always turn on at exactly 5 PM.

The above descriptions detail ways that the remote can be used to control devices in homes. The remote can also be used to query or control devices in industrial applications. For example, the remote can be used in a concert venue to control lighting and sound. In this application, the sound board and light board are the two host devices. The user can sit anywhere in the theater-a balcony, front row, back row, etc. and adjust the lighting and sound using the remote.

The remote can also be used to control and monitor production equipment. For example, in a chemical plant, the host can be attached to processing vats. The host would transmit data concerning inflow and outflow rates, internal temperature and pressure, etc. The user could adjust these parameters if desired using the remote.

Similarly, the remote could be used in a plastic injection molding factory. Individual machines would have hosts, who would transfer data such as cycle time, pressure, temperatures at different locations, lot size, estimated completion time, etc. The user can adjust parameters as necessary-for example, change the heating parameters to compensate for a heater band having failed.

Other plant machinery would have hosts that transmit screens or other information to the remote control allowing it to control speed up, slow down, perform a certain number of operations before turning off, or controlled in other ways. In addition, warning conditions, such as overheating, running out of raw material, or running out of available space may also be sent to the remote control.

Traffic. A host associated with one or multiple lights could transmit screens or other information to a remote control to allow traffic engineers to adjust the timing of stoplights in real time to improve traffic flow. The remote can be used to adjust the timing of each individual light. Based on the screens or other information the host transmits to the remote control, the engineer can tweak the signal, observe the changes in traffic flow, and then adjust quickly. Multiple lights can be controlled via a repeater or WAN system allowing one a multiplicity of hosts to transmit screens or other information to one or more remote controls so that changes can be made to a large area simultaneously. In this case, the remote would display a listing sent by the host(s) for each light. The engineer would select a particular light to change and make the modifications. For example, making changes to the light at the intersection of 13^{th} and J St may cause traffic to back up two blocks way, on 15^{th} street. The timing of the lights at 15^{th} street may then be adjusted. The host may even be removable to prevent tampering with the light timing.

Although particular embodiments of the invention have been described in detail, it is understood that the invention is not limited correspondingly in scope, but includes all changes, modifications and equivalents coming within the spirit and terms of the claims appended hereto.

1. A modular audio/video assembly comprising:
a plurality of audio/video components including at least one source component and at least one destination component;
a plurality of buses at least one of which is usable by no more than a subset of said plurality of audio/video components; and
a central processing unit capable of coupling a subset of said plurality of buses to a subset of said plurality of audio/video components.

2. The modular audio/video assembly of claim 1 wherein said plurality of buses includes an audio in bus and a video in bus, and the audio in bus and the video in bus are capable of being connected to different source components.

3. The modular audio/video assembly of claim 1 wherein all signals transmitted on said plurality of buses are digitized signals.

4. The modular audio/video assembly of claim 1 wherein all signals transmitted on said plurality of buses are digital signals.

5. The modular audio/video assembly of claim 1 wherein each of a first subset of said plurality of buses is capable of being an input transmitting only digital signals to said central processing unit and each of a second subset of said plurality of buses is capable of being an output from said central processing unit transmitting only digital signals.

6. The combination of claim 5 wherein each of said first plurality of buses is coupled to an analog to digital converter and each of said second plurality of buses is coupled to a digital to analog converter.

7. The modular audio/video assembly of claim 1 wherein said central processing unit has an input and an output each capable of being coupled to predetermined ones of said audio/video components, and said assembly further includes a selector/multiplexer for selecting predetermined outputs of said plurality of audio/video source components as audio outputs and predetermined outputs of said plurality of audio/video source components as video outputs.

8. The modular audio/video assembly of claim 7 wherein said selector/multiplexer includes components of said central processing unit.

9. The modular audio/video assembly of claim 7 wherein said plurality of buses includes an audio in bus and a video in bus, and the audio in bus and the video in bus are capable of being connected to different source components.

10. A modular audio/video assembly comprising:
a plurality of audio/video components including at least one source component and at least one destination component;
a plurality of buses at least one of which is usable by no more than a subset of said plurality of audio/video components;
a plurality of bays each for receiving one of said plurality of audio/video components and each capable of being coupled to at least a subset of said plurality of buses; and
a central processing unit capable of coupling predetermined ones of said at least one source component to predetermined ones of said at least one destination component through predetermined ones of said plurality of buses.

11. The combination of claim 10 wherein at least one of said bays is capable of being coupled to all of said plurality of buses.

12. The modular audio/video assembly of claim 10 wherein all signals transmitted on said plurality of buses are digitized signals.

13. The modular audio/video assembly of claim 10 wherein said and at least one bay of said plurality of bays and the audio/video component received by said at least one bay lock into place mechanically by a locking mechanism that includes a switch having at least first and a second positions, said switch when in said first position applying power to said bay in a manner to prevent said component from being damaged when powered up, and when in said second position removing power from said bay to power down said component prior to its removal.

14. The modular audio/video assembly of claim 10 wherein said central processing unit has an input and an output each capable of being coupled to predetermined ones of said audio/video components, and said assembly further includes a selector/multiplexer wherein at least some of the components comprising said selector/multiplexer comprise components of said central processing unit, for selecting predetermined outputs of said plurality of audio/video source components as audio outputs and predetermined outputs of said plurality of audio/video source components as video outputs.

15. The modular audio/video assembly of claim 10 wherein said plurality of buses includes an audio in bus, a video in bus, an audio out bus, a video out bus, a high speed bus and a low speed bus.

16. A modular audio/video assembly comprising:
a plurality of audio/video components including at least one source component and at least one destination component;
a plurality of buses, said plurality including an audio in bus, a video in bus, an audio out bus, a video out bus, a high speed bus and a low speed bus, at least one of which is usable by no more than a subset of said plurality of audio/video components;
a plurality of bays each for receiving one of said plurality of audio/video components, each capable of being coupled to at least one of said plurality of buses; and
a central processing unit capable of coupling a subset of said plurality of buses to a subset of said plurality of audio/video components, said central processing unit having an input and an output and said assembly further includes a selector/multiplexer for selecting predetermined outputs of said plurality of audio/video source components as audio outputs and predetermined outputs of said plurality of audio/video source components said video outputs.

17. The combination of claim 16 wherein said selector/multiplexer includes components of said central processing unit.

18. The modular audio/video assembly of claim 16 wherein all signals transmitted on said plurality of buses are digitized signals.

19. A modular audio/video assembly comprising:
a plurality of audio/video components including at least one source component and one destination component;
a plurality of buses at least one of which is usable by no more than a subset of said plurality of audio/video components;
a selector/multiplexer for selecting predetermined outputs of said plurality of audio/video source components as audio outputs and predetermined outputs of said plurality of audio/video source components as video outputs; and
a central processing unit capable of coupling said audio outputs and said video outputs to predetermined ones of said destination components.

20. A modular audio/video assembly comprising a plurality of audio/video components including source components and destination components, wherein all signals transmitted from said source components to said destination components are transmitted on an input bus and an output bus, all of said signals transmitted on said buses being digitized signals.

21. A modular audio/video assembly comprising:
a plurality of audio/video components including at least one source component and at least one destination component;
a plurality of buses at least one of which is usable by no more than a subset of said plurality of audio/video components;
a central processing unit capable of coupling a subset of said plurality of buses to a subset of said plurality of audio/video components;
a first subset of said plurality of buses connected as inputs to said central processing unit, said first subset comprising a plurality of digital video streams;
a second subset of said plurality of said buses connected as inputs to said central processing unit, said second subset comprising a plurality of digital audio streams;
a third subset of said plurality of said buses connected as outputs from said central processing unit, said third subset comprising a plurality of digital video output streams; and
a fourth subset of said plurality of said buses connected as outputs from said central processing unit, said fourth subset comprising a plurality of digital audio output streams.

22. The combination of claim 21 wherein said each member of said first and second subsets are outputs from an analog to digital converter and each member of said third and fourth subsets are inputs to a digital to analog converter.

23. A modular audio/video assembly capable of housing a plurality of audio/video components including at least one source component and at least one destination component comprising:
a plurality of buses at least one of which is usable by no more than a subset of said plurality of audio/video components; and
a central processing unit capable of coupling a subset of said plurality of buses to a subset of said plurality of audio/video components.

24. The modular audio/video assembly of claim 23 wherein said plurality of buses includes an audio in bus and a video in bus, and the audio in bus and the video in bus are capable of being connected to different source components.

25. The modular audio/video assembly of claim 23 wherein all signals transmitted on said plurality of buses are digitized signals.

26. The modular audio/video assembly of claim 23 wherein all signals transmitted on said plurality of buses are digital signals.

27. The modular audio/video assembly of claim 23 wherein each of a first subset of said plurality of buses is capable of being an input transmitting only digital signals to said central processing unit and each of a second subset of said plurality of buses is capable of being an output from said central processing unit transmitting only digital signals.

28. The combination of claim 27 wherein each of said first plurality of buses is coupled to an analog to digital converter and each of said second plurality of buses is coupled to a digital to analog converter.

29. The modular audio/video assembly of claim 23 wherein said central processing unit has an input and an output each capable of being coupled to predetermined ones of said audio/video components, and said assembly further includes a selector/multiplexer for selecting predetermined outputs of said plurality of audio/video source components as audio outputs and predetermined outputs of said plurality of audio/video source components as video outputs.

30. The modular audio/video assembly of claim 29 wherein said selector/multiplexer includes components of said central processing unit.

31. The modular audio/video assembly of claim 29 wherein said plurality of buses includes an audio in bus and a video in bus, and the audio in bus and the video in bus are capable of being connected to different source components.

32. A modular audio/video assembly capable of housing a plurality of audio/video components including at least one source component and at least one destination component comprising:
a plurality of buses at least one of which is usable by no more than a subset of said plurality of audio/video components;
a plurality of bays each for receiving one of said plurality of audio/video components and each capable of being coupled to at least a subset of said plurality of buses; and
a central processing unit capable of coupling predetermined ones of said at least one source component to predetermined ones of said at least one destination component through predetermined ones of said plurality of buses.

33. The combination of claim 32 wherein at least one of said bays is capable of being coupled to all of said plurality of buses.

34. The modular audio/video assembly of claim 32 wherein all signals transmitted on said plurality of buses are digitized signals.

35. The modular audio/video assembly of claim 32 wherein said and at least one bay of said plurality of bays and the audio/video component received by said at least one bay lock into place mechanically by a locking mechanism that includes a switch having at least first and a second positions, said switch when in said first position applying power to said bay in a manner to prevent said component from being damaged when powered up, and when in said second position removing power from said bay to power down said component prior to its removal.

36. The modular audio/video assembly of claim 32 wherein said central processing unit has an input and an output each capable of being coupled to predetermined ones of said audio/video components, and said assembly further includes a selector/multiplexer wherein at least some of the components comprising said selector/multiplexer comprise components of said central processing unit, for selecting predetermined outputs of said plurality of audio/video source components as audio outputs and predetermined outputs of said plurality of audio/video source components as video outputs.

37. The modular audio/video assembly of claim 32 wherein said plurality of buses includes an audio in bus, a video in bus, an audio out bus, a video out bus, a high speed bus and a low speed bus.

38. A modular audio/video assembly capable of housing a plurality of audio/video components including at least one source component and at least one destination component, comprising:
a plurality of buses, said plurality including an audio in bus, a video in bus, an audio out bus, a video out bus, a high speed bus and a low speed bus, at least one of which is usable by no more than a subset of said plurality of audio/video components;
a plurality of bays each for receiving one of said plurality of audio/video components, each capable of being coupled to at least one of said plurality of buses; and
a central processing unit capable of coupling a subset of said plurality of buses to a subset of said plurality of audio/video components, said central processing unit having an input and an output and said assembly further includes a selector/multiplexer for selecting predetermined outputs of said plurality of audio/video source components as audio outputs and predetermined outputs of said plurality of audio/video source components said video outputs.

39. The combination of claim 38 wherein said selector/multiplexer includes components of said central processing unit.

40. The modular audio/video assembly of claim 38 wherein all signals transmitted on said plurality of buses are digitized signals.

41. A modular audio/video assembly capable of housing a plurality of audio/video components including at least one source component and one destination component, comprising:
a plurality of buses at least one of which is usable by no more than a subset of said plurality of audio/video components;
a selector/multiplexer for selecting predetermined outputs of said plurality of audio/video source components as audio outputs and predetermined outputs of said plurality of audio/video source components as video outputs; and
a central processing unit capable of coupling said audio outputs and said video outputs to predetermined ones of said destination components.

42. A modular audio/video assembly capable of housing a plurality of audio/video components including source components and destination components, wherein all signals transmitted from said source components to said destination components are transmitted on an input bus and an output bus, all of said signals transmitted on said buses being digitized signals.

43. A modular audio/video assembly capable of housing a plurality of audio/video components including at least one source component and at least one destination component, comprising:
a plurality of buses at least one of which is usable by no more than a subset of said plurality of audio/video components;
a central processing unit capable of coupling a subset of said plurality of buses to a subset of said plurality of audio/video components;
a first subset of said plurality of buses connected as inputs to said central processing unit, said first subset comprising a plurality of digital video streams;
a second subset of said plurality of said buses connected as inputs to said central processing unit, said second subset comprising a plurality of digital audio streams;
a third subset of said plurality of said buses connected as outputs from said central processing unit, said third subset comprising a plurality of digital video output streams; and
a fourth subset of said plurality of said buses connected as outputs from said central processing unit, said fourth subset comprising a plurality of digital audio output streams.

44. The combination of claim 43 wherein said each member of said first and second subsets are outputs from an analog to digital converter and each member of said third and fourth subsets are inputs to a digital to analog converter.

45. The process of selecting one of two independent information streams, one from a video source and one from an audio source, in a modular audio/video assembly having a plurality of audio sources and a plurality of video sources controlled by a remote control having the option of selecting a video information stream covering a broadcast event when an audio information stream covering said broadcast event has been set as the default information stream, comprising: selecting a video information stream covering said broadcast event as the video source when the audio information stream covering said broadcast event is set as the default audio source.

46. The process of selecting two independent information streams, one from a video source and one from an audio source, in a modular audio/video assembly having a plurality of audio sources and a plurality of video sources controlled by a remote control having the option of selecting a video information stream and an audio information stream, comprising:
displaying the audio sources available;
selecting one of the displayed audio sources covering a broadcast event;
displaying the video sources available; and
selecting one of the displayed video sources covering said broadcast event.

47. The process of selecting two independent information streams in a modular audio/video assembly having a plurality of audio sources and a plurality of video sources controlled by a remote control having the option of selecting a video viewing option and an audio viewing option, comprising:
displaying the video sources available;
selecting one of the displayed video sources covering a broadcast event;
displaying the audio sources available; and
selecting one of the displayed audio sources covering said broadcast event.

48. The process of recognizing an audio/video component newly installed in a modular audio video system by power cycling said system comprising:
recognizing a signal from said system indicating that said component has been installed;
in response to recognizing said signal, said system turning its power off;
said system turning power back on;
initializing said newly installed component during or after said step of turning said power back on; and
as part of said initializing step, loading a driver required for said newly installed component.

49. The process of claim 45 further including logging on to a website containing versions of said driver and determining whether a newer version of said driver is available for said newly installed component.

50. The process of recognizing an audio/video component newly installed in a modular audio video system by power cycling said system comprising:
recognizing a signal from said system indicating that said component has been installed;
in response to recognizing said signal, displaying on a monitor a message asking if the user wants to power cycle the system;
detecting a signal transmitted by said user by a remote control indicating that said user wants to power cycle the system; and
in response to detecting said signal transmitted by said user, power cycling said system.

51. The process of claim 50 wherein said power cycling said system comprises:
said system turning its power off;
said system turning power back on;
initializing said newly installed component during or after said step of turning said power back on; and
as part of said initializing step, loading a driver for said newly installed component.

52. The process of claim 51 including the further step of logging on to a website containing versions of said driver and determining whether a newer version of said driver is available for said newly installed component.

53. The process of a host in a modular audio/video assembly that includes receptacles for receiving components controllable by a remote control, said host preparing information to be transmitted to a remote control, said process comprising:
said host identifying components installed in said host and the functions that those components support;
said host detecting that said remote control is active in the vicinity of said host;
said host communicating with said remote control to determine the status of said remote;
said host preparing, in response to determining said status and in response to the components installed in said host, first information identifying functions in said host controllable by said remote control to be transmitted to said remote control.

54. The process of claim 53 further including said host transmitting said first information to said remote.

55. The process of claim 53 including preparing additional control information usable by said remote control for transmission to said remote after transmission of said first information.

56. The process of claim 55 wherein said preparing additional information includes said host detecting an indication of the control information currently used by said remote control to control said currently installed components, and preparing information to be subsequently used by said remote control to control said currently installed components.

57. The process of claim 53 wherein said identifying includes:
detecting the application of power to said host;
querying each receptacle sequentially to detect the presence or absence of a signal indicating that said receptacle has an installed component;
interrogating, in response to detecting the presence of said signal, the component installed in said receptacle to determine its type;
after determining said type, loading into memory the appropriate software modules for controlling said component;
storing said type in an inventory of installed components; and
interrogating another receptacle in response to detecting the absence of said signal.

58. The process of claim 57 including continuing said interrogation until all receptacles have been interrogated.

59. The process of claim 53 wherein said identifying includes:
detecting the application of power to said host,
querying at least some of said receptacles in parallel to detect the presence or absence of signals indicating said receptacles have installed components;
interrogating, in response to detecting the presence of said signal, the component installed in said receptacle to determine its type;
after determining said type, loading into memory the appropriate software modules for controlling said component; and
storing said type in an inventory of installed components.

60. The process of a host in modular audio/video assembly having installed components, sending control information to a remote control that has the capability of displaying control information as screens, comprising:
said host detecting that said remote control is active in the vicinity of said host;
said host communicating with said remote control to determine the current screen displayed on said remote control;
said host determining, in response to said current screen and the components installed in said host, an initial screen to be displayed on said remote control.

61. The process of claim 60 wherein said communicating comprises said host determining if said remote is displaying a startup screen and said initial screen is a starting point screen for the use of said remote control.

62. The process of claim 60 further including said host preparing subsequent screens to the initial screen.

63. The process of claim 60, including said host, in response to detecting that said remote control is displaying a startup screen, preparing subsequent screens to said starting point screen to send to said remote control.

64. The process of a host for an audio/video component having certain controllable functions responding to a remote control, said host preparing control information usable to control said device, comprising:
said host identifying the controllable functions and control information therefor that said remote control will require, said identifying occurring before the time said remote control requires said control information.

65. The process of claim 64 further including said host sending said control information to said remote control.

66. The process of claim 64 wherein said information comprises information capable of being displayed as a screen on said remote control.

67. The process of claim 66 wherein said host formats said control information in a logical manner for subsequent display on a screen of said remote control.

68. The process of claim 67 further including said host translating said control information to be transmitted into a compact language format for rapid transmission to said remote control.

69. The process of claim 68 wherein said language is HTML.

70. The process of a host in a modular audio/video assembly that has installed components controllable by a remote control that operates upon control information to control said components, said process comprising said host determining, in response to the components installed in said host, initial control information to be operated upon by said remote control.

71. The process by a host in a modular audio/video assembly that includes components having controlled functions controllable by a remote control, said process comprising said host identifying information for controlling said controlled functions that said remote control will select in the future, and sending said information to said remote control for future use by said remote control.

72. One or more processor readable storage devices having processor readable code embodied on said processor readable storage devices, said processor readable code for programming one or more processors to perform a process of selecting one of two independent information streams, one from a video source and one from an audio source, in a modular audio/video assembly having a plurality of audio sources and a plurality of video sources controlled by a remote control having the option of selecting a video information stream covering a broadcast event when an audio information stream covering said broadcast event has been set as the default information stream, comprising:
selecting a video information stream covering said broadcast event as the video source when the audio information stream covering said broadcast event is set as the default audio source.

73. One or more processor readable storage devices having processor readable code embodied on said processor readable storage devices, said processor readable code for programming one or more processors to perform a process of selecting two independent information streams, one from a video source and one from an audio source, in a system having a plurality of audio sources and a plurality of video sources controlled by a remote control having the option of selecting a video information stream and an audio information stream, comprising:
displaying the audio sources available;
selecting one of the displayed audio sources covering a broadcast event;
displaying the video sources available; and
selecting one of the displayed video sources covering said broadcast event.

74. One or more processor readable storage devices having processor readable code embodied on said processor readable storage devices, said processor readable code for programming one or more processors to perform a process of selecting two independent information streams in an audio/video system having a plurality of audio sources and a plurality of video sources controlled by a remote control having the option of selecting a video viewing option and an audio viewing option, comprising:
displaying the video sources available;
selecting one of the displayed video sources covering a broadcast event;
displaying the audio sources available; and
selecting one of the displayed audio sources covering said broadcast event.

75. One or more processor readable storage devices having processor readable code embodied on said processor readable storage devices, said processor readable code for programming one or more processors to perform a process of recognizing an audio/video component newly installed in an audio/video system by power cycling said system comprising:
recognizing a signal from said system indicating that said component has been installed;
in response to recognizing said signal, said system turning its power off;
said system turning power back on;
initializing said newly installed component during or after said step of turning said power back on; and
as part of said initializing step, loading a driver required for said newly installed component.

76. The one or more processor readable storage devices of claim 75, said one or more processes further including logging on to a website containing versions of said driver and determining whether a newer version of said driver is available for said newly installed component.

77. One or more processor readable storage devices having processor readable code embodied on said processor readable storage devices, said processor readable code for programming one or more processors to perform a process of recognizing an audio/video component newly installed in an audio/video system by power cycling said system comprising:
recognizing a signal from said system indicating that said component has been installed;
in response to recognizing said signal, displaying on a monitor a message asking if the user wants to power cycle the system;
detecting a signal transmitted by said user by a remote control indicating that said user wants to power cycle the system; and
in response to detecting said signal transmitted by said user, power cycling said system.

78. The one or more processor readable storage devices of claim 77 wherein said power cycling said system comprises:
said system turning its power off;
said system turning power back on;
initializing said newly installed component during or after said step of turning said power back on; and
as part of said initializing step, loading a driver for said newly installed component.

79. The one or more processor readable storage devices of claim 78, said one or more processes including the further step of logging on to a website containing versions of said driver and determining whether a newer version of said driver is available for said newly installed component.

80. One or more processor readable storage devices having processor readable code embodied on said processor readable storage devices, said processor readable code for programming one or more processors to perform a process of a host in a modular audio/video assembly that includes receptacles for receiving components controllable by a remote control, said host preparing information to be transmitted to a remote control, said process comprising:
said host identifying components installed in said host and the functions that those components support;
said host detecting that said remote control is active in the vicinity of said host;
said host communicating with said remote control to determine the status of said remote;
said host preparing, in response to determining said status and in response to the components installed in said host, first information identifying functions in said host controllable by said remote control to be transmitted to said remote control.

81. The one or more processor readable storage devices of claim 80, said one or more processes further including said host transmitting said first information to said remote.

82. The one or more processor readable storage devices of claim 80, said one or more processes including preparing additional control information usable by said remote control for transmission to said remote after transmission of said first information.

83. The one or more processor readable storage devices of claim 82 wherein said preparing additional control information includes said host detecting an indication of the control information currently used by said remote control to control said installed components, and preparing information to be subsequently used by said remote control to control said installed components.

84. The one or more processor readable storage devices of claim 80 wherein said identifying includes:
detecting the application of power to said host;
querying each receptacle sequentially to detect the presence or absence of a signal indicating that said receptacle has an installed component;
interrogating, in response to detecting the presence of said signal, the component installed in said receptacle to determine its type;
after determining said type, loading into memory the appropriate software modules for using said component;
storing said type in an inventory of installed components; and
interrogating another receptacle in response to detecting the absence of said signal.

85. The one or more processor readable storage devices of claim 84, said one or more processes including continuing said interrogation until all receptacles have been interrogated.

86. The one or more processor readable storage devices of claim 80 wherein said identifying includes:
detecting the application of power to said host,
querying at least some of said receptacles in parallel to detect the presence or absence of signals indicating said receptacles have installed components;
interrogating, in response to detecting the presence of said signal, the component installed in said receptacle to determine its type;
after determining said type, loading into memory the appropriate software modules for using said component; and
storing said type in an inventory of installed components.

87. One or more processor readable storage devices having processor readable code embodied on said processor readable storage devices, said processor readable code for programming one or more processors to perform a process of a host in a modular audio/video assembly having installed components, said host sending control information to a remote control that has the capability of displaying control information as screens, comprising:
said host detecting that said remote control is active in the vicinity of said host;
said host communicating with said remote control to determine the current screen displayed on said remote control; and
said host determining, in response to said current screen and the components installed in said host, an initial screen to be displayed on said remote control.

88. The one or more processor readable storage devices of claim 87, wherein said communicating comprises said host determining if said remote is displaying a startup screen and said initial screen is a starting point screen for the use of said remote control.

89. The one or more processor readable storage devices of claim 87, said one or more processes further including said host preparing subsequent screens to the initial screen.

90. The one or more processor readable storage devices of claim 87, said one or more processes including said host, in response to detecting that said remote control is displaying a startup screen, preparing subsequent screens to said starting point screen to send to said remote control.

91. One or more processor readable storage devices having processor readable code embodied on said processor readable storage devices, said processor readable code for programming one or more processors to perform a process of a host for an audio/video component having certain controllable functions responding to a remote control, preparing control information usable to control said device, comprising:
said host identifying the controllable functions and control information thereof that said remote control will require, said identifying occurring before the time said remote control requires said control information.

92. The one or more processor readable storage devices of claim 91, said one or more processes further including said host sending said control information to said remote control.

93. The one or more processor readable storage devices of claim 91 wherein said control information comprises information capable of being displayed as a screen on said remote control.

94. The one or more processor readable storage devices of claim 91 wherein said host formats said control information in a logical manner for subsequent display on a screen of said remote control.

95. The one or more processor readable storage devices of claim 94, said one or more processes further including said host translating said control information to be transmitted into a compact language format for rapid transmission to said remote control.

96. The one or more processor readable storage devices of claim 95 wherein said language is HTML.

97. One or more processor readable storage devices having processor readable code embodied on said processor readable storage devices, said processor readable code for programming one or more processors to perform a process of a host in a modular audio/video assembly that includes components controllable by a remote control that operates upon control information to control said components, said process comprising said host determining, in response to the components installed in said host, initial control information to be operated upon by said remote control.

98. One or more processor readable storage devices having processor readable code embodied on said processor readable storage devices, said processor readable code for programming one or more processors to perform a process in a host for a modular audio/video assembly that includes components having controlled functions controllable by a remote control, said process comprising said host identifying information for controlling said controlled functions that said remote control will select in the future, and sending said information to said remote control for future use by said remote control.

99. The process of a host for audio/video components controllable by a remote control, said process comprising: said host storing information to be transmitted to a remote control for controlling said components;
said host identifying said controllable components and the functions that those components support;
said host detecting that said remote control is active in the vicinity of said host; and
said host transmitting to said remote control all, or subset of, said information.

100. One or more processor readable storage devices having processor readable code embodied on said processor readable storage devices, said processor readable code for programming one or more processors to perform the process of a host for audio/video components controllable by a remote control, said process comprising: said host storing information to be transmitted to a remote control for controlling said components;
said host identifying said controllable components and the functions that those components support;
said host detecting that said remote control is active in the vicinity of said host; and
said host transmitting to said remote control all, or subset of, said information.

101. The process of a host for components controllable by a remote control, said host storing information to be transmitted to a remote control for controlling said components, said process comprising:
said host identifying said controllable components and the functions that those components support;
said host detecting that said remote control is active in the vicinity of said host; and
said host transmitting to said remote control all, or subset of, said information.

102. One or more processor readable storage devices having processor readable code embodied on said processor readable storage devices, said processor readable code for programming one or more processors to perform the process of a host for components controllable by a remote control, said host storing information to be transmitted to a remote control for controlling said components, said process comprising:
said host identifying said controllable components and the functions that those components support;
said host detecting that said remote control is active in the vicinity of said host; and
said host transmitting to said remote control all, or subset of, said information.

103. A modular audio/video assembly, comprising:
a housing;
a main board disposed within the housing; and
a plurality of interfaces associated with the main board, each interface coupleable to a module that provides audio/video functionality for the assembly, and wherein the main board and respective modules are cooperative to provide a set of selected audio/video functions.

104. The assembly according to claim 103, wherein the respective modules comprise at least one of an audio tuner and a video tuner.

105. The assembly according to claim 104, wherein the respective modules further comprise at least one of a CD player, a DVD player, a video tape player and a memory.

106. The assembly according to claim 103, wherein the housing includes selectively removable knockouts for accessing interfaces of respective modules.

107. The assembly according to claim 103, wherein the housing includes selectively operable doors for accessing interfaces of respective modules.

108. The assembly according to claim 103, further comprising a wiring assembly to connect at least one of the modules to a one of the interfaces of the main board.

109. The assembly according to claim 103, wherein the main board includes a processor for executing logic instructions to carry out at least one audio/video function.

110. The assembly according to claim 109, wherein the processor is a video processor.

111. The assembly according to claim 109, wherein the main board further includes a memory for storing the logic instructions.

112. The assembly according to claim 109, wherein the main board further includes an audio/video multiplexer for switching a desired audio/video signal from one of a plurality of signal sources to the processor.

113. The assembly according to claim 109, wherein the main board further includes a local interface for coupling the processor to each of the interfaces.

114. The assembly according to claim 103, wherein at least one of the modules executes logic to provide a respective audio/video function of the module.

115. The assembly according to claim 103, wherein the assembly effectuates user input commands to switch from one channel to another channel of a video tuner.

116. The assembly according to claim 115, wherein the user input commands are wirelessly received from a remote control.

117. The assembly according to claim 103, wherein the assembly effectuates user input commands to alter the gain of an audio amplifier, thereby selectively increasing or decreasing audible output from speakers coupled to the assembly.

118. The assembly according to claim 115, wherein the user input commands are wirelessly received from a remote control.

119. The assembly according to claim 103, wherein at least one interface is configured to receive an edge connector of one of the modules.

120. A method of assembling an audio/video assembly, comprising:
providing a housing and a main board having a plurality of interfaces;
selecting at least one module having audio/video functionality; and
connecting the module to one of the interfaces such that the module and the main board cooperatively provide a set of selected audio/video functions.

121. The method according to claim 120, wherein the audio/video functionality includes at least one of an audio tuner and a video tuner.

122. The method according to claim 121, wherein the audio/video functionality further includes at least one of a CD player, a DVD player, a video tape player and a memory.

123. The method according to claim 120, wherein connecting the module includes removing a knockout of the housing.

124. The method according to claim 120, wherein the main board includes a processor for executing logic instructions to carry out at least one audio/video function.

125. The method according to claim 124, wherein the processor is a video processor.

126. The method according to claim 124, wherein the main board further includes a memory for storing the logic instructions.

127. The method according to claim 124, wherein the main board further includes an audio/video multiplexer for switching a desired audio/video signal from one of a plurality of signal sources to the processor.

128. The method according to claim 124, wherein the main board further includes a local interface for coupling the processor to each of the interfaces.

129. The method according to claim 120, wherein at least one of the modules executes logic to provide a respective audio/video function of the module.

130. The method according to claim 120, wherein the assembly effectuates user input commands to switch from one channel to another channel of a video tuner.

131. The method according to claim 130, further comprising providing a remote control to wirelessly transmit the user input commands to the assembly.

132. The method according to claim 120, wherein the assembly effectuates user input commands to alter the gain of an audio amplifier, thereby selectively increasing or decreasing audible output from speakers coupled to the assembly.

133. The method according to claim 132, further comprising providing a remote control to wirelessly transmit the user input commands to the assembly.

134. The method according to claim 120, wherein connecting the module includes inserting an edge connector of the module into a receptacle of the interface.

135. A method of assembling an audio/video assembly, comprising:
receiving a set of desired audio/video functions from a consumer; and
connecting a plurality of modules each having audio/video functionality to respective interfaces of a main board such that the modules and the main board cooperatively provide the set of desired audio/video functions.

136. The method according to claim 135, further comprising providing the consumer with a menu of audio/video functions such that the set of desired audio/video functions is derived from the menu.

137. The method according to claim 135, wherein the set of desired audio/video functions is comprised of a list of consumer specified modules.

138. The method according to claim 135, wherein the desired audio/video functions is a list of desired functionality and further comprising converting the list of desired functionality to a list that includes specific modules.

139. The method according to claim 135, wherein the set of desired audio/video functions includes at least one of an audio tuner and a video tuner.

140. The method according to claim 135, wherein the set of desired audio/video functions further includes at least one of a CD player, a DVD player, a video tape player and a memory.

141. The method according to claim 135, wherein the main board includes a processor for executing logic instructions to carry out at least one audio/video function.

142. The method according to claim 141, wherein the processor is a video processor.

143. The method according to claim 141, wherein the main board further includes a memory for storing the logic instructions.

144. The method according to claim 141, wherein the main board further includes an audio/video multiplexer for switching a desired audio/video signal from one of a plurality of signal sources to the processor.

145. The method according to claim 141, wherein the main board further includes a local interface for coupling the processor to each of the interfaces.

146. The method according to claim 135, wherein at least one of the modules executes logic to provide a respective audio/video function of the module.

147. The method according to claim 135, wherein the assembly effectuates user input commands to switch from one channel to another channel of a video tuner.

148. The method according to claim 147, further comprising providing a remote control to wirelessly transmit the user input commands to the assembly.

149. The method according to claim 135, wherein the assembly effectuates user input commands to alter the gain of an audio amplifier, thereby selectively increasing or decreasing audible output from speakers coupled to the assembly.

150. The method according to claim 149, further comprising providing a remote control to wirelessly transmit the user input commands to the assembly.

151. The method according to claim 135, wherein connecting the module includes inserting an edge connector of the module into a receptacle of the interface.
